(19) United States
(12) Patent Application Publication
(10) Pub. No.: US 2011/0099075 A1
(43) Pub. Date: Apr. 28, 2011

(54) VEHICLE ADVERTISING SYSTEM

(75) Inventor: Micheal N. Hannon, Chardon, OH (US)

(73) Assignee: GRAPHIC LAMINATING, LLC, Solon, OH (US)

(21) Appl. No.: 12/673,174

(22) PCT Filed: Aug. 12, 2008
(86) PCT No.: PCT/US08/72848

§ 371 Date: Jan. 12, 2011

Related U.S. Application Data
(60) Provisional application No. 60/955,545, filed on Aug. 13, 2007.

(51) Int. Cl. G06Q 30/00; G09F 21/04

(52) U.S. Cl. 705/14.68; 40/591

(57) ABSTRACT

A mobile advertising system includes a banner, a first banner anchor and a second banner anchor coupled to a vehicle. The banner is capable of being deployed by being connected at opposing ends to and suspended between the first and second banner anchors. The banner has first and second surfaces on which indicia are imprinted. Both the first and second banner surfaces are visible when the banner is deployed. An invoicing and tracking system may be included that computes an advertising charge based at least in part on a time period during which the banner is deployed and, optionally, a location of the vehicle.

### CROSS REFERENCE TO RELATED APPLICATIONS

This application claims the benefit of U.S. Provisional patent application Ser. No. 60/955,545, entitled “Vehicle Advertising System” filed Aug. 13, 2007, the entire disclosure of which is incorporated herein by reference, to the extent that it is not conflicting with the present application.

### BACKGROUND OF THE INVENTION

Outdoor structures and methods are well-known in the advertising field of art to advertise and promote products and services. Some examples include billboards along roads, digital signs in urban locations, and the exterior vertical sides of truck trailers. Few other efficient and revenue generating methods for advertising in the transportation industry exist.

### SUMMARY OF THE INVENTION

A mobile advertising system includes a banner, a first banner anchor and a second banner anchor coupled to a vehicle. The banner is capable of being deployed by being connected at opposing ends to and suspended between the first and second banner anchors. The banner has first and second surfaces on which indicia are imprinted. Both the first and second banner surfaces are visible when the banner is deployed. An invoicing and tracking system may be included that computes an advertising charge based at least in part on a time period during which the banner is deployed and, optionally, a location of the vehicle.

A method of advertising includes providing a banner capable of being deployed by being connected at opposing ends to and suspended between first and second anchors coupled to a vehicle. The banner has first and second surfaces on which indicia are imprinted and both the first and second banner surfaces are visible when the banner is deployed. A determination of whether the banner is deployed is made and a time period during which the banner is deployed is accumulated. An advertising charge is computed based at least in part on the time period during which the banner is deployed.

A system for computing an advertising charge for a given advertiser includes a banner sensor that senses if the banner is deployed and a usage timer that determines a time period during which the banner is deployed based at least in part on data from the banner sensor. A vehicle location tracker determines a location of the vehicle during the time period the banner is deployed. A cost computer computes advertising charges based at least in part on the vehicle location and time period during which the banner is deployed. An invoice generator accumulates and communicates the computed advertising charges to the advertiser.

### BRIEF DESCRIPTION OF THE DRAWINGS

Features and advantages of the invention will become apparent from the following detailed description made with reference to the accompanying drawings, wherein:

FIG. 1 is a perspective view of a vehicle advertising system installed on a vehicle;

FIG. 2 is a perspective view of a banner assembly of the vehicle advertising system of FIG. 1 constructed in accordance with an embodiment of the present invention;

FIG. 3 is a side view of the banner assembly of the vehicle advertising system of FIG. 1 constructed in accordance with an embodiment of the present invention;

FIGS. 4A-4B are perspective views of a front mast of the vehicle advertising system of FIG. 1 constructed in accordance with an embodiment of the present invention;

FIGS. 5A-5B are perspective views of a rear mast of the vehicle advertising system of FIG. 1 constructed in accordance with an embodiment of the present invention;

FIGS. 6A-6B are perspective views of a rear mast of a vehicle advertising system constructed in accordance with an alternative embodiment of the present invention;

FIGS. 6C-6D are perspective views of a rear mast of a vehicle advertising system constructed in accordance with an alternative embodiment of the present invention;

FIG. 7 is a perspective view of a front mast of a vehicle advertising system that shows the rear mast in a stowed position in accordance with an embodiment of the present invention;

FIG. 8 is a functional block diagram of a tracking and invoicing system for use with a vehicle advertising system in accordance with an embodiment of the present invention; and

FIG. 9 is a flowchart of a method of tracking and invoicing for use with a vehicle advertising system in accordance with an embodiment of the present invention.

### DETAILED DESCRIPTION OF THE INVENTION

This Detailed Description of the Invention merely describes embodiments of the invention and is not intended to limit the scope of the claims in any way. Indeed, the invention as described is broader than and unlimited by the embodiments described herein, and the terms used have their full ordinary meaning.

According to an inventive aspect of the present application, a mobile advertising system employs hardware and data collection and transmission electronics to create a revenue generating advertising system based on implementation time and location variables. The system includes assembly hardware that is installed on a mobile transportation vehicle, and may also include system vehicle electronics that are also installed on the vehicle and/or remote electronics installed at a receiving base location. Unique software and other processing components may also be included.

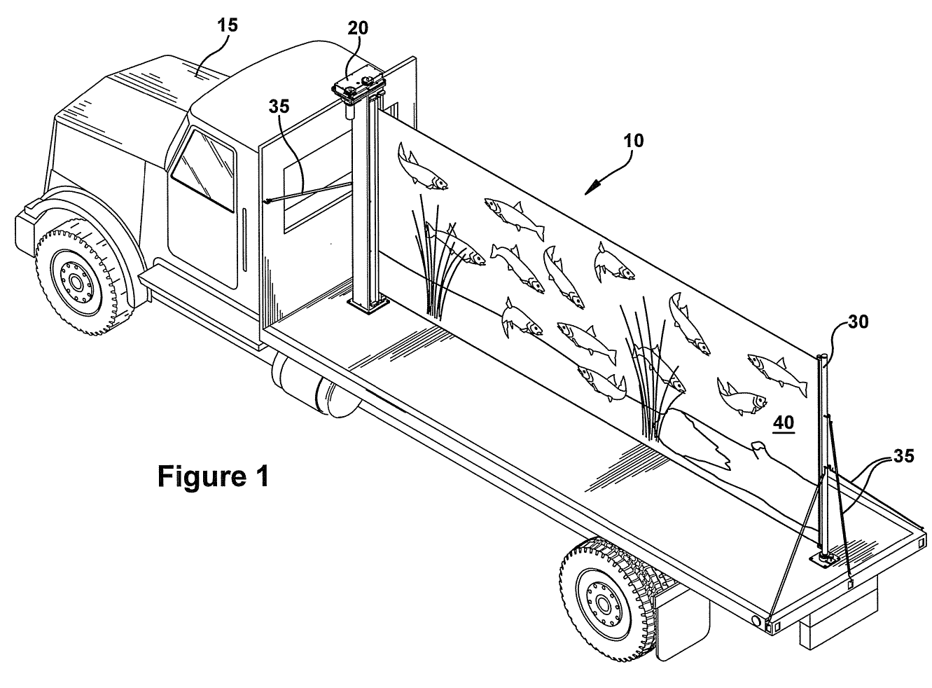

FIGS. 1-9 illustrate exemplary embodiments of a mobile advertising system according to inventive aspects of the present application. The mobile advertising system includes a banner assembly 10 shown installed on a vehicle in FIG. 1. The system utilizes free time to generate advertising revenue when no obstructing load is carried by the vehicle, such as, for example, a flat bed truck. In this example, the banner assembly 10 would be positioned parallel to the length of the bed and slightly off center toward the driver's side to accommodate a winch (not shown). While a flat bed truck 15 is shown in FIG. 1, any vehicle that includes a surface suitable for mounting a banner can be used in practice of the invention. It should be understood that other assembly locations and other vehicle types can be utilized in the practice of this invention. For example, a barge or towed trailer could also be used to carry the banner assembly 10.

The banner assembly 10 includes a banner 40 and first and second banner anchors coupled to the vehicle, such as, for example, a front mast 20, a rear mast 30. When the mobile advertising system is in use, the front mast 20 and rear mast 30 are anchored to the vehicle and may also be stabilized by one or more cables 35 connected to the front and rear masts. The height of the connection point on the cable 35, and the location of the opposing connection point of the cable 35 may vary. The banner 40 is deployed from the front mast 20 and connected to the rear mast 30. While the banner 40 described herein is a retractable banner, any suitable type of banner may be used in practice of the invention, including a removable banner (not shown) that is hung between the front and rear masts and is completely removed from the masts when not in use.

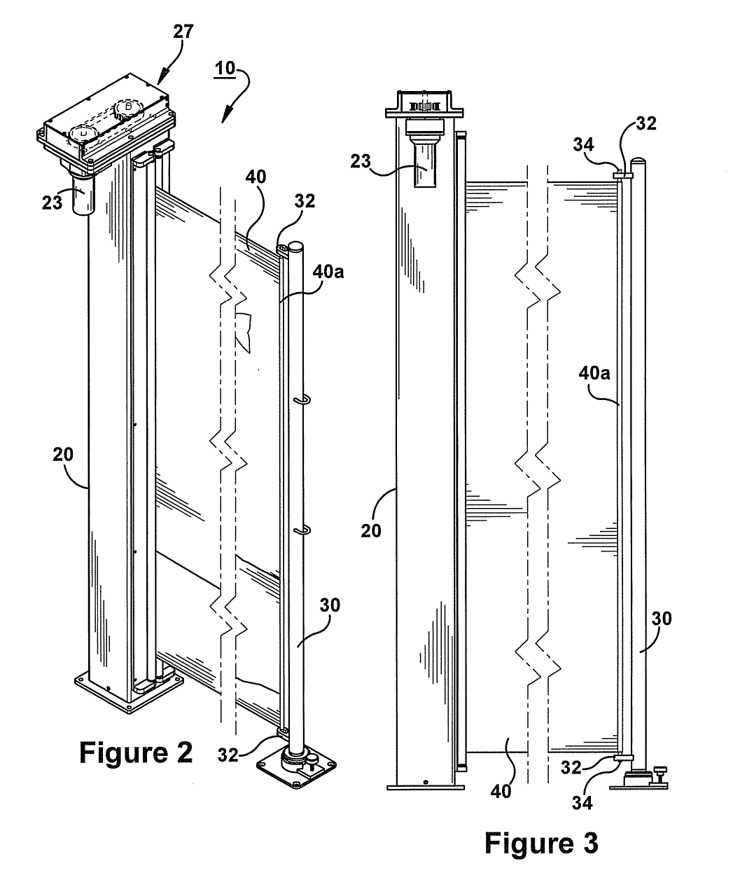

FIGS. 2 and 3 are views of the banner assembly 10. The front mast 20 forms a first mounting point for one end of the banner 40. The front mast 20 is mounted to the truck bed floor by bolts or any suitable technique and can be reinforced by tie downs such as the cables 35 (FIG. 1) or any structure at two other points. Alternatively, the front mast may be readily removable from the vehicle when not in use. In some embodiments, the opposite end of the banner 40 includes a hem 40a that is adapted to receive a hem rod 34. In the illustrated embodiment, the hem rod 34 is inserted through the hem 40a and snapped into clips 32 located at the top and bottom of the rear mast 30. Other structure can be employed to secure the hem rod.

Referring again to FIGS. 2 and 3, the banner 40 is thus deployed from the front mast 20 and is installed to the rear mast 30. The banner can be made from vinyl or any other suitable material resistant to tearing, inclement weather, or other types of damage. Text and images can be printed on either side to create a two-sided advertisement.

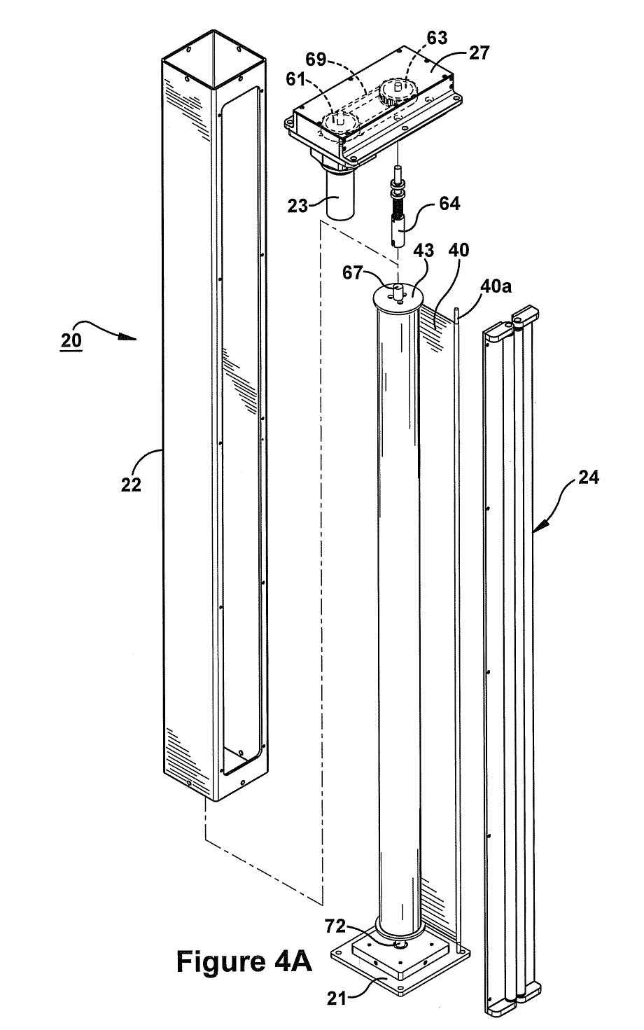

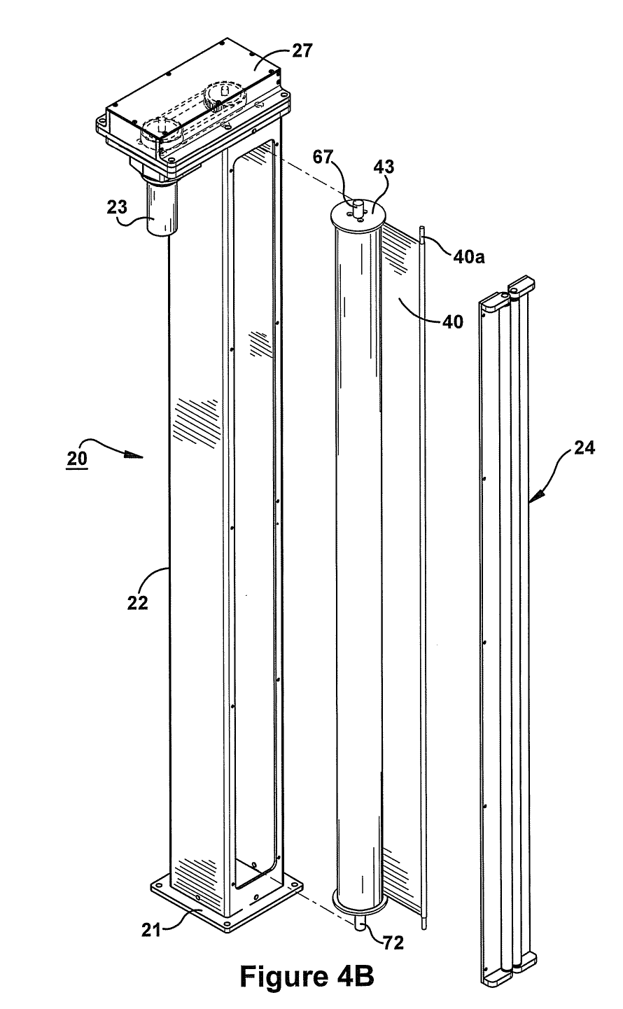

FIGS. 4A and 4B are exploded perspective views of the front mast 20. The front mast 20 includes a banner enclosure 22 in which a removable banner spool 43 is installed. A winch motor 23 engages a drive assembly 27 that forms a top portion of the front mast 20. The drive assembly 27 includes a motor gear 61, a toothed belt 69, and a spindle gear 63. When energized, the winch motor 23 drives the motor gear 61. The toothed belt 69 drives the spindle gear 63 to deploy or retract the banner, depending on the direction the winch motor is turning. Of course, any means of translating motor rotation into spool rotation can be used. For example, the drive assembly may include, for example, a gear set that is driven by the winch motor 23 to deploy or retract the banner. A switch (not shown) on the front mast 20 or a remote control (not shown) is used to operate the winch motor.

As shown in FIG. 4B, a banner access plate 24 is removable from the enclosure 22 to provide access to the interior of the banner enclosure 22 for installation of the banner spool 43. The banner 40 is wound around the spool 43 and the spool includes a spindle top 67 that is configured to engage a spindle receiver 64. In the described embodiment, the spindle receiver 64 is spring loaded to maintain a compressive force on the spool 43 when it is installed. The spindle receiver 64 engages and is driven by the spindle gear 63. The banner access plate 24 includes a slot through which the banner is fed and one or more wiper mechanisms, such as, for example, rollers 25 or brushes (not shown) on either side of the slot that remove debris from the banner prior to its being retracted into the front mast 20.

A front mast base 21 is fixed to the vehicle. The front mast base 21 is configured to accept a spindle bottom 72 such that the spindle bottom can rotate with respect to the front mast base. The front mast 20 provides tension to the entire banner, impeding movement by wind or motion. Any tension mechanism may be used in the practice of the invention, such as for example, a spring loaded mechanism (not shown) or operation of the winch motor to draw and maintain the banner taut upon installation. In using the system, a system owner or operator will on occasion need to change the banner because of a new advertiser. The banner spool 43 can be removed from the front mast 20 through the banner access plate 24.

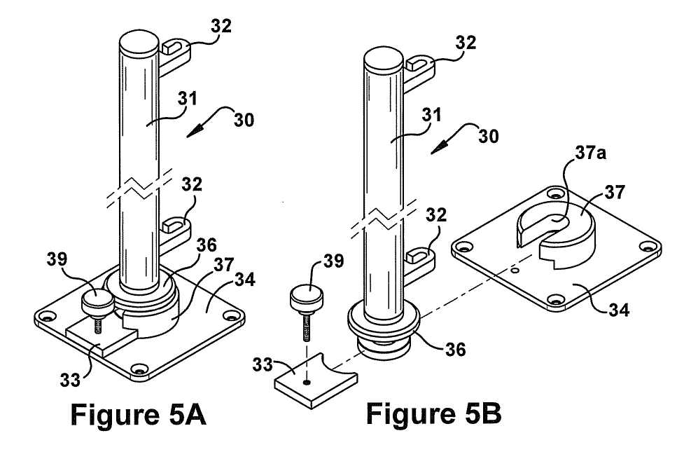

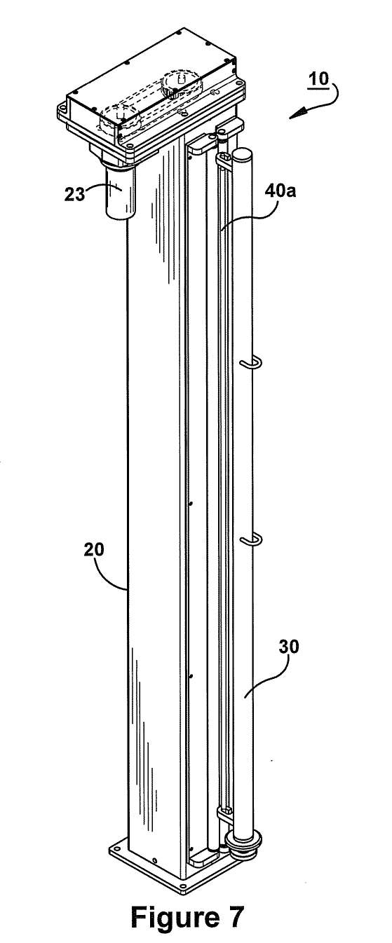

FIGS. 5A and 5B are a perspective views of the rear mast 30. The rear mast 30 includes the clips 32 that accept the hem rod 34 (FIGS. 2 and 3) and maintain the banner in the deployed position. The rear mast 30 includes a pole 31 that is removably fixed to a rear mast base 34. In the described embodiment, the pole 31 includes a mounting flange 36 that is configured to rest on a keyed mounting boss 37. To fix the pole 31 to the rear mast base 34 the pole is inserted into a key slot 37a in the keyed mounting boss 37. Once the pole 31 is installed in the keyed mounting boss 37, a key 33 is anchored to the rear mast base 34 with a pin 39 to prevent movement of the pole 31 out of the key slot 37a. The banner tension tends to keep the pole 31 in the key slot of the keyed mounting boss 37. Three point loading of the pole 31, such as by cables 35 (FIG. 1) can also be used. When the vehicle is empty of any load that forms an obstruction, the banner can be displayed by placing the rear mast 30 in position and attaching it to the key slot in the keyed mounting boss 37. When a load is on the vehicle, the banner 40 is retracted and the rear mast 30 is in a stowed position attached to the front mast (see e.g., FIG. 7).

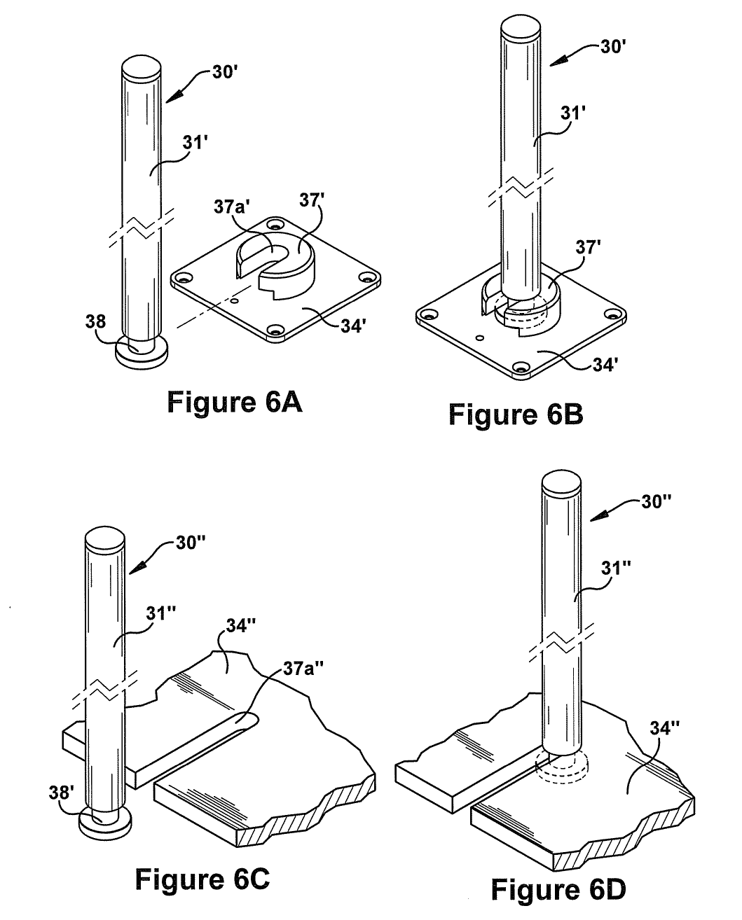

FIGS. 6A and 6B are perspective views of an alternative rear mast 30′. In this embodiment, the rear mast 30′ does not include clips to accept a hem rod. Instead, the rear mast 30′ includes a removable pole 31′ that serves the same purpose as the hem rod. The removable pole 31′ has a key groove 38 near its bottom. The removable pole 31′ is sized to be inserted in the hem 40a of the banner 40. The key groove 38 is configured to be removably installed in a key slot 37a in a keyed mounting boss 37′.

FIGS. 6C and 6D are perspective views of an alternative rear mast 30″. Like rear mast 30′, rear mast 30″ does not include clips to accept a hem rod. Instead, rear mast 30″ includes a removable pole 31″ that serves the same purpose as the hem rod. The removable pole 31″ has a key groove 38′ near its bottom. The removable pole 31″ is sized to be inserted in the hem 40a of the banner 40. In this embodiment, the key groove 38′ is configured to be removably installed in a key slot 37a″ in the bed of a flat bed 34a″.

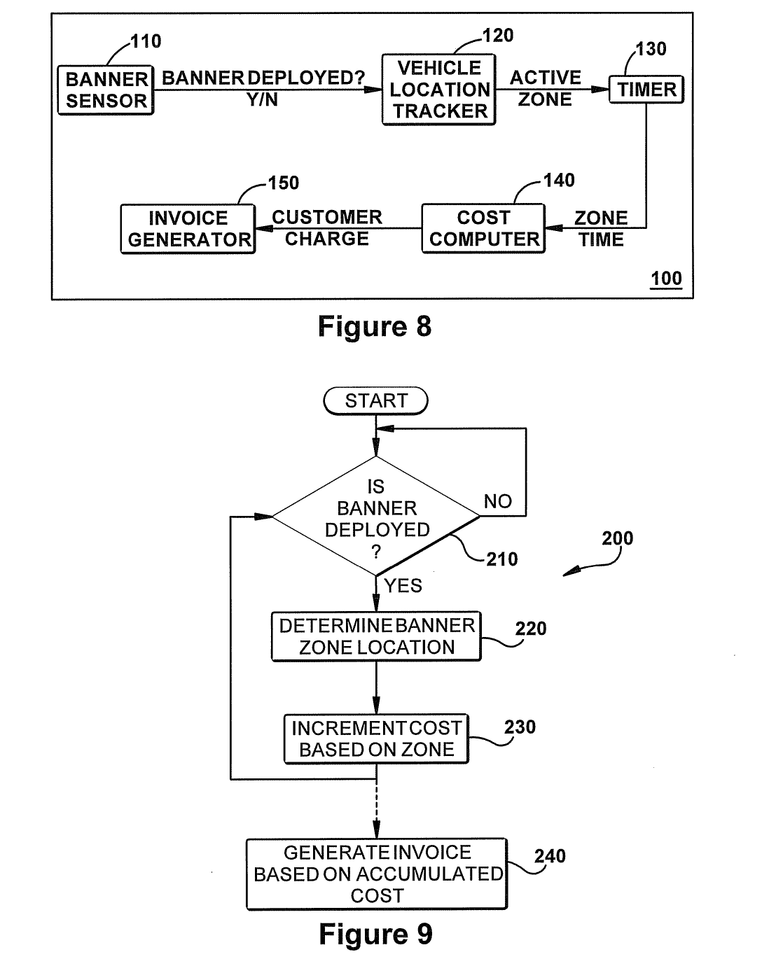

The system is designed to collect and transmit data regarding the time and location of the vehicle during periods in which the banner 40 is deployed to a fully extended position, i.e., time the vehicle acts as a piece of advertisement. FIG. 8 is a functional block diagram of a tracking and invoicing system 100 that can be used with the mobile advertising system. The tracking and invoicing system includes a banner sensor 110 that provides a signal that indicates whether the banner is deployed or not. The banner sensor may be for example, a proximity switch that senses the presence of the banner in the fully extended position or a position of a drive assembly component. Alternatively, the banner sensor may be a manual switch operating by the user of the system. A Global Positioning System (GPS) real time location tracker 120, such as for example, the SAGEQUEST™ system, is incorporated into the system to track the vehicle's location during deployment of the banner. It will relay information to a usage timer 130 that collects data regarding vehicle location, actual date and time, and whether or not the banner is deployed. The information can be relayed at any interval, such as for example, 1, 2, or 5 minutes. The data from the timer 130 of one or more vehicles is be collected by a cost computer 140. The cost computer provides data regarding advertiser charges to an invoice generator 150 that accumulates and communicates the advertising charges to the advertiser by generating invoices or updating cost information in some manner that will be accessible by the advertiser, such as, for example, an encrypted website. Based on advertising contracts, the collected data can be used to determine rates for billing cycles or determine future rates. It will be apparent to one of skill in the art that any or all of the vehicle location tracker 120, the timer 130, the cost computer 140, and the invoice generator may be located in a remote central server or on each vehicle.

The use of a GPS tracking components in the advertising system electronics can be utilized for other purposes, such as for example, by a fleet operator to determine location of individual trucks. This can eliminate the need for a stand-alone GPS system in a vehicle when a fleet operator desires a real time location system.

FIG. 9 is a flowchart that illustrates one exemplary method 200 of operating the mobile advertising system. At 210, the status of the banner is determined. If the banner is deployed at 220, the location of the banner (and the vehicle it is mounted on) is determined. In addition, the location tracker may determine whether or not the vehicle is in motion. The region through which the vehicles travels may be divided into zones, with each zone having its own billing rate. At 230, an incremental cost to the advertiser is computed based at least in part on the time of deployment and the zone in which the banner is located and, optionally, whether the vehicle is in motion. At 240, an invoice is generated at some predetermined interval based on accumulated cost data. The invoice may be in the form a periodic statement or in an update of billing information on a website that is accessible to advertisers.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

I claim:

1. A mobile advertising system comprising:
a banner having first and second surfaces on which indicia are imprinted;
a first banner anchor coupled to a vehicle; and
a second banner anchor coupled to the vehicle;
wherein the banner is capable of being deployed by being connected at opposing ends to and suspended between the first and second banner anchors such that the first and second banner surfaces are visible when the banner is deployed.

2. The mobile advertising system of claim 1 wherein the first banner anchor comprises a front mast and the banner comprises a retractable banner; and further wherein the banner is fixed to the front mast in a manner that allows the banner to be deployed from the front mast and attached to the second banner anchor.

3. The mobile advertising system of claim 2 wherein the front mast comprises a banner enclosure that encloses substantially an entirety of the banner when the banner is retracted.

4. The mobile advertising system of claim 2 comprising a winch motor operably coupled to a drive assembly, the drive assembly configured to translate motor rotation to deploy or retract the banner from the front mast.

5. The mobile advertising system of claim 4 wherein the retractable banner is rolled onto a spool that is configured to engage and be driven by the drive assembly.

6. The mobile advertising system of claim 2 wherein the rear mast comprises a hem rod that is inserted through a banner hem and is removably coupled to a rear mast base.

7. The mobile advertising system of claim 1 comprising an invoicing system that computes an advertising charge based at least in part on an amount of time the banner is deployed.

8. The mobile advertising system of claim 7 comprising a location tracking system that determines a location of the mobile advertising system and wherein the invoicing system receives location data from a GPS tracking system and computes an advertising charge based at least in part on the location data.

9. The mobile advertising system of claim 8 wherein the location tracking system is adapted to determine whether the mobile advertising system is in motion or is stationary and wherein the invoicing system receives data from the location tracking system corresponding to whether the mobile advertising system is in motion or is stationary and computes the advertising charge based at least in part on whether the mobile advertising system is in motion or is stationary.

10. The mobile advertising system of claim 8 wherein the invoicing system computes the advertising charge based at least in part on one of at least two billing rates associated with one of at least two particular location zones in which the mobile advertising system is located.

11. A method of advertising comprising:
providing a banner capable of being deployed by being connected at opposing ends to and suspended between first and second banner anchors coupled to a vehicle, the banner having a first and second surface on which indicia are imprinted and wherein both the first and second banner surfaces are visible when the banner is deployed;
determining whether the banner is deployed;
accumulating a time period during which the banner is deployed; and
computing an advertising charge based at least in part on the time period during which the banner is deployed.

12. The method of claim 11 comprising the step of determining a location of the vehicle when the banner is deployed and wherein the step of computing an advertising charge is performed based at least in part on the location of the vehicle during the time period in which the banner is deployed.

13. The method of claim 12 wherein the step of computing an advertising charge includes the step of selecting a billing rate from at least two different billing rates wherein each billing rate is associated with one of at least two location zones.

14. The method of claim 11 comprising the step of determining whether the vehicle is in motion and wherein the step of computing an advertising charge includes the step of selecting a billing rate from at least two different billing rates, wherein a first billing rate is selected when the vehicle is in motion and a second billing rate is selected when the vehicle is not in motion.

15. For use with a deployable banner carried by a vehicle, a system for computing an advertising charge for a given advertiser comprising:
a banner sensor that senses if the banner is deployed;
a usage timer that determines a time period during which the banner is deployed based at least in part on data from the banner sensor;
a vehicle location tracker that determines a location of the vehicle during the time period the banner is deployed;
a cost computer that computes advertising charges based at least in part on the vehicle location and time period during which the banner is deployed; and
an invoice generator that accumulates and communicates the computed advertising charges to the advertiser.

16. The system for computing an advertising charge of claim 15 wherein the vehicle location tracker is configured to detect a rate of vehicle motion and wherein the cost computer computes advertising charges based at least in part on a rate of vehicle motion.

17. The system for computing an advertising charge of claim 15 wherein the cost computer computes the advertising charges by selecting a billing rate from at least two billing rates, wherein each billing rate corresponds to a different location zone and by multiplying the selected billing rate by the amount of time period during which the banner was deployed and the vehicle was located within the corresponding location zone.

18. The system for computing an advertising charge of claim 15 wherein the vehicle location tracker comprises a GPS system.
